(19) United States
(12) Patent Application Publication
(10) Pub. No.: US 2025/0224375 A1
(43) Pub. Date: Jul. 10, 2025

(54) EDDY CURRENT FLAW DETECTING DEVICE, AND EDDY CURRENT FLAW DETECTING METHOD

(71) Applicant: IHI Corporation, Tokyo (JP)

(72) Inventors: Atsuko NUMA, Tokyo (JP); Koichi INAGAKI, Tokyo (JP)

(73) Assignee: IHI Corporation, Tokyo (JP)

(21) Appl. No.: 19/089,249

(22) Filed: Mar. 25, 2025

Related U.S. Application Data
(63) Continuation of application No. PCT/JP2023/034627, filed on Sep. 25, 2023.

(30) Foreign Application Priority Data
Jan. 13, 2023 (JP) 2023-003825

(51) Int. Cl. G01N 27/9013; G01N 27/90

(52) U.S. Cl. CPC G01N 27/902; G01N 27/9046

(57) ABSTRACT

An inspection device (1) includes a probe (10) that scans a surface (51) of a standard piece (50), the surface having a shape corresponding to a component surface (41), along scanning paths (P) on the surface to be scanned having different shapes, and detecting a change in a first eddy current on the surface (51) of the standard piece (50) in each of the scanning paths (P). The inspection device (1) includes a determination unit (21) that determines a sensitivity of the probe (10) in each of the scanning paths (P) based on an intensity of a first signal indicating a change in the first eddy current in each of the scanning paths (P). The inspection device (1) includes a correction unit (22) that corrects an intensity of a second signal indicating a change in a second eddy current on the component surface (41) detected by the probe (10) based on the sensitivity of the probe (10).

### CROSS-REFERENCE TO RELATED APPLICATIONS

The present application is a continuation application of International Application No. PCT/JP2023/034627, now WO 2024/150474 A1, filed on Sep. 25, 2023, which claims priority to Japanese Patent Application No. 2023-003825, filed on Jan. 13, 2023, the entire contents of which are incorporated by reference herein.

### BACKGROUND OF THE INVENTION

### Technical Field

The present disclosure relates to an eddy current flaw detecting device and eddy current flaw detecting method.

### Background

The eddy current flaw detecting method disclosed in JP 2022-1847 A includes a step A for acquiring a flaw detection signal based on an eddy current generated in an object to be inspected and an electrical conductivity of the object to be inspected, and a step B for correcting the flaw detection signal to generate a corrected flaw detection signal. In the step B, correction information associated with the electrical conductivity is collated with the electrical conductivity obtained in step A, thereby specifying a correction amount and generating a corrected flaw detection signal.

### SUMMARY OF INVENTION

By the way, an eddy current flaw detection test has been performed to detect scratches on a surface of a metal component, for example. In the eddy current flaw detection test, a probe is scanned on a surface of a component to be inspected, and changes in eddy current generated on the surface are detected. Thus, scratches on the component surface can be detected. Here, for example, the sensitivity of the probe may decrease due to the difference between the shape of the component surface and the shape of the probe. Therefore, depending on the shape of the component surface, the probe may be replaced with a probe having a more suitable shape. In such a case, the probe may be replaced during the eddy current flaw detection test for one component, and the inspection process may become complicated.

An eddy current flaw detecting device according to the present disclosure is an eddy current flaw detecting device for inspecting a component surface, including: a probe configured to scan a surface of a standard piece, the surface having a shape corresponding to the component surface, along scanning paths on the surface to be scanned having different shapes, and detecting a change in a first eddy current on the surface of the standard piece in each of the scanning paths; a determination unit configured to determine a sensitivity of the probe in each of the scanning paths based on an intensity of a first signal indicating a change in the first eddy current in each of the scanning paths; and a correction unit configured to correct an intensity of a second signal indicating a change in a second eddy current on the component surface detected by the probe based on the sensitivity.

In the eddy current flaw detecting device, each of the scanning paths may extend across a groove portion formed on the surface of the standard piece and deeper than a penetration depth of the first eddy current; and the first signal may be a signal indicating the change in the first eddy current detected when the probe crosses the groove portion.

In the eddy current flaw detecting device, the determination unit may determine the sensitivity based on the ratio of the intensity of the first signal in a first path in which the first signal having the largest intensity among the scanning paths is detected and the intensity of the first signal in the path other than the first path among the scanning paths.

In the eddy current flaw detecting device, the correction unit may calculate a correction value in each of the scanning paths based on the sensitivity, and correct the intensity of the second signal based on the correction value.

An eddy current flaw detecting method according to the present disclosure is an eddy current flaw detecting method for inspecting a component surface, including: scanning a surface of a standard piece by a probe, the surface having a shape corresponding to the component surface, along scanning paths on the surface to be scanned having different shapes, and detecting a change in a first eddy current on the surface of the standard piece in each of the scanning paths; determining a sensitivity of the probe in each of the scanning paths based on an intensity of a first signal indicating a change in the first eddy current in each of the scanning paths; and correcting an intensity of a second signal indicating a change in a second eddy current on the component surface detected by the probe based on the sensitivity.

According to the present disclosure, it is possible to provide an eddy current flaw detecting device and an eddy current flaw detecting method capable of more easily performing an eddy current flaw detection test.

### BRIEF DESCRIPTION OF DRAWINGS

FIG. 1 is a schematic perspective view showing an example of the overall configuration of an eddy current flaw detecting device according to an embodiment.

FIG. 2 is a schematic perspective view showing an inspection object of the eddy current flaw detecting device according to an embodiment.

FIG. 3 is a block diagram showing an example of the overall configuration of an eddy current flaw detecting device according to an embodiment.

FIG. 4 is a schematic view showing a probe of an eddy current flaw detecting device according to an embodiment.

FIG. 5 is a schematic perspective view showing a standard piece used in performing an eddy current flaw detection test in an eddy current flaw detecting device according to an embodiment.

FIG. 6 is a schematic plan view of a main part of the standard piece shown in FIG. 5 showing the standard piece used in performing the eddy current flaw detection test in the eddy current flaw detecting device according to an embodiment, and is an explanatory view for explaining an example of the operation of the eddy current flaw detecting device.

FIG. 7 is a schematic arrow view showing a main part of the standard piece shown in FIG. 6, as viewed from the direction of arrow B, showing the standard piece used in performing the eddy current flaw detection test in the eddy current flaw detecting device according to an embodiment, and is an explanatory view for explaining an example of the operation of the eddy current flaw detecting device.

FIG. 8 is an explanatory view for explaining a first determination process performed in the eddy current flaw detecting device according to an embodiment, and is a graph showing an example of a sensitivity of a probe in each of scanning paths.

FIG. 9 is an explanatory view for explaining a second determination process performed in the eddy current flaw detecting device according to an embodiment, and is a graph showing an example of a correction value in each of the scanning paths.

### DESCRIPTION OF EMBODIMENTS

Hereinafter, some exemplary embodiments will be described with reference to the drawings. Elements having the same function are denoted by the same reference numerals, and duplicate descriptions are omitted.

A X-axis direction in each figure is the direction in which a first slider 4a, which will be described later, can move, and the positive X-axis direction and the negative X-axis direction are referred to simply as the “X-axis direction”. A Y-axis direction is the direction in which a second slider 4b, which will be described later, can move, and the positive Y-axis direction and the negative Y-axis direction are referred to simply as the “Y-axis direction”. A Z-axis direction is the direction in which a third slider 4c, which will be described later, can move, and the positive Z-axis direction and the negative Z-axis direction are referred to simply as the “Z-axis direction”. The positive Z-axis direction corresponds to the upward direction, and the negative Z-axis direction corresponds to the downward direction. The X-axis direction, the Y-axis direction, and the Z-axis direction cross each other, and may be substantially orthogonal to each other, for example. A θ-axis direction is the direction of rotation around an axis A1, which will be described later, and the positive θ-axis direction and the negative θ-axis direction are referred to simply as the “θ-axis direction”. A P-axis direction is the direction of rotation about the extending direction of a probe shaft 7, which will be described later, and the positive P-axis direction and the negative P-axis direction are referred to simply as the “P-axis direction”. An R-axis direction is the direction of rotation around an axis A2 of a stage 6, which will be described later, and the positive R-axis direction and the negative R-axis direction are referred to simply as the “R-axis direction”.

The eddy current flaw detecting device and eddy current flaw detecting method according to the embodiment can be used for eddy current flaw detection test. In the eddy current flaw detection test, the presence or absence of defects, such as cracks, which exist in an electrically conductive inspection object can be inspected. The eddy current flaw detection test is also called ET (Eddy current testing).

In the eddy current flaw detection test, an eddy current is generated on a surface of the inspection object by forming a magnetic field on the surface of the inspection object with an excitation coil. Then, the magnetic field induced by the eddy current is detected by a detection coil. When a defect exists on the surface of the inspection object, the flow path of the eddy current changes due to the effect of the defect. As a result, the magnetic field induced by the eddy current changes. By detecting such a change in the magnetic field by the detection coil, it is possible to determine whether a defect exists on the surface of the inspection object. That is, the state of the surface of the inspection object can be inspected by detecting the change in eddy current caused by the presence or absence of defects.

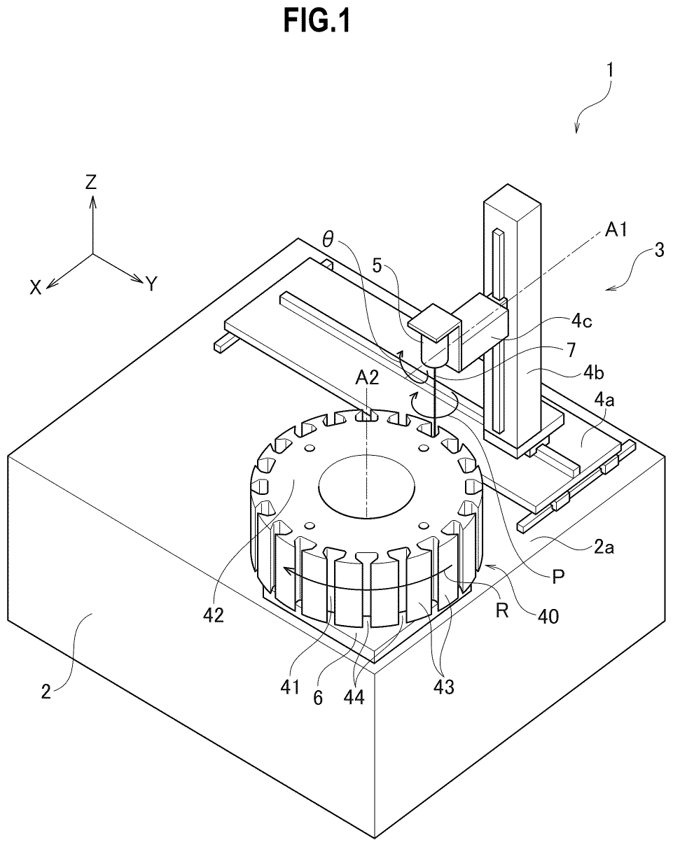

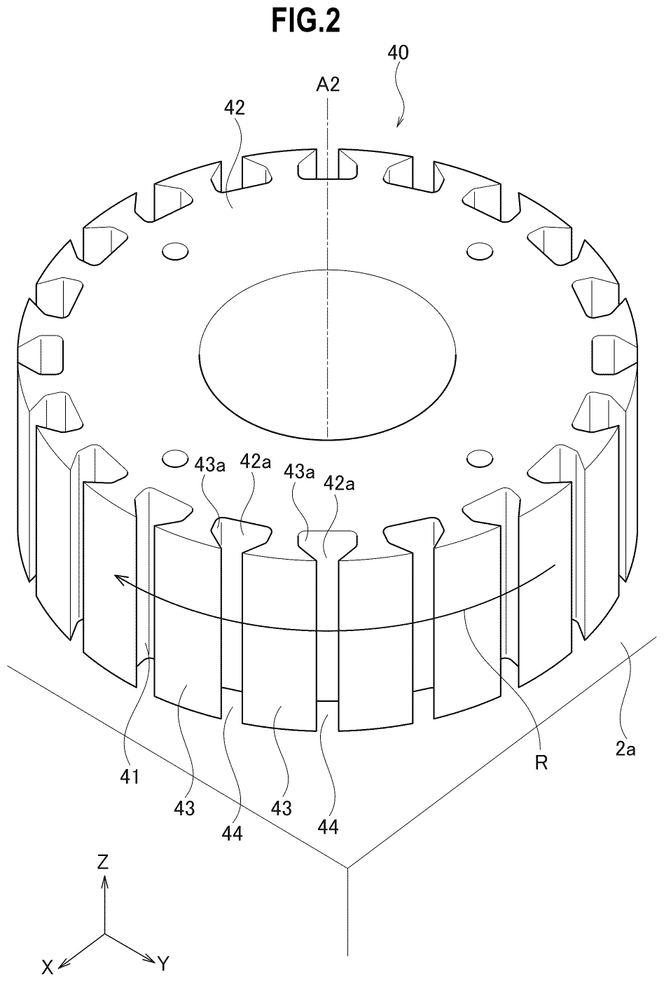

First, examples of the inspection device 1 and the inspection object will be described with reference to FIGS. 1 and 2. The inspection device 1 is an eddy current flaw detecting device for inspecting a component surface 41. The component surface 41 is a surface of a component 40 as the inspection object and is a surface to be subjected to the eddy current flaw detection test. The component surface 41 may be a part of the entire surface of the component 40. The inspection device 1 performs an eddy current flaw detection test to determine whether or not a defect exists on the component surface 41. The structure of the inspection device 1 is not limited to the structure illustrated in the figure, and the structure may be appropriately changed according to the shape, size, installation location of the inspection device 1, type of the component 40, etc.

As illustrated in FIG. 1, the inspection device 1 includes a frame 2 and a drive mechanism 3. The frame 2 is constituted by combining, for example, metal columns and beams. An upper surface 2a is formed on the upper portion of the frame 2. A component 40 (see FIG. 2) can be placed on the upper surface 2a. The upper surface 2a may extend substantially parallel to the XY plane.

The component 40 illustrated in FIGS. 1 and 2 has a substantially cylindrical shape as a whole. The component 40 is made of, for example, metal. When the component 40 is placed on the upper surface 2a, the central axis of the cylindrical shape may extend substantially parallel to the Z-axis direction. The component 40 has, for example, a body 42, projections 43, and slots 44.

The body 42 constitutes a part of the component 40 from the inner peripheral side of the component 40 to the outer peripheral side of the component 40. The projections 43 are arranged on the outer peripheral side of the body 42. That is, projections 43 and slots 44 are formed on the outer peripheral part of the component 40. The projections 43 are formed to extend outward in the radial direction of the component 40 from the body 42, and may extend vertically when the component 40 is placed on the upper surface 2a. Each of the projections 43 may be located on the circumference of the same circle around the axis A2 in plan view, and each of the projections 43 may be formed to be spaced at a predetermined interval in the R-axis direction. Slots 44 are formed between two of the projections 43 adjacent to each other. The slots 44 are groove portions extending vertically when the component 40 is placed on the upper surface 2a. Slots 44 may be formed at a predetermined interval in the R-axis direction on the outer periphery of the component 40. The shape, size or posture of the component 40 are not limited to the example shown in the figure.

The slot 44 is defined by an outer peripheral surface 42a of the body 42 and side surfaces 43a of the projections 43. The outer peripheral surface 42a forms a part of the outer peripheral portion of the body 42. The side surface 43a forms a part of the projection 43 in the R-axis direction.

The drive mechanism 3 is a mechanism for controlling the position or posture of the probe 10 or component 40, which will be described later. The drive mechanism 3 may be disposed at a predetermined position on the upper surface 2a. The drive mechanism 3 may have, for example, at least one of a first slider 4a, a second slider 4b, a third slider 4c, a holding member 5, and a stage 6.

The first slider 4a is a member movable in the X-axis direction in an area above the upper surface 2a. The first slider 4a may be a long metal member extending in the Y-axis direction. The first slider 4a may be movable in the X-axis direction by sliding along a rail extending in the X-axis direction disposed on the upper surface 2a, for example.

The second slider 4b is a member movable in the Y-axis direction in an area above the upper surface 2a. The second slider 4b may be a long metal member extending in the Z-axis direction. The second slider 4b may be movable in the Y-axis direction on the first slider 4a by sliding along a rail extending in the Y-axis direction disposed on the upper surface of the first slider 4a, for example.

The third slider 4c is a member movable in the Z-axis direction in an area above the upper surface 2a. The third slider 4c may be a member extending in the X-axis direction. The third slider 4c may be movable in the Z-axis direction by sliding along a rail extending in the Z-axis direction disposed on the second slider 4b, for example. The third slider 4c is attached to the second slider 4b to project in the X-axis positive direction from the X-axis positive side surface of the second slider 4b. A holding member 5 may be fixed to the end of the third slider 4c on the positive X-axis side.

The holding member 5 holds an end of the probe shaft 7, and in the state illustrated in FIG. 1, the probe shaft 7 extends from the holding member 5 in the negative Z-axis direction. A probe 10 (see FIG. 4) is attached to a tip of the probe shaft 7 on the negative Z-axis side. That is, the probe shaft 7 is a member connecting the holding member 5 and the probe 10. The holding member 5 may rotatably hold the probe shaft 7 around its extending direction. Thus, the holding member 5 can rotate the probe 10 in the P-axis direction. The holding member 5 may be fixed to the third slider 4c to be rotatable around the axis A1. Thus, it is possible to rotate the holding member 5 in the θ-axis direction around the axis A1 as the center axis. The axis A1 is an axis extending in the X-axis direction.

The stage 6 is a member capable of supporting the component 40 and is disposed in a predetermined region of the upper surface 2a. The stage 6 may be rotatable around the axis A2. That is, the stage 6 may rotatably support the component 40 about around axis A2. The axis A2 illustrated in FIG. 1 is an axis extending in the Z-axis direction, but is not limited thereto. For example, the axis A2 may be inclined with respect to the Z-axis.

With such a drive mechanism 3, for example, by adjusting the positions of the first slider 4a, the second slider 4b, and the third slider 4c, the positions of the probe 10 in the X-axis direction, the Y-axis direction, and the Z-axis direction can be adjusted. Also, by adjusting the rotation of the probe shaft 7 in the P-axis direction, the orientation of the coil 11 described later in the probe 10 can be adjusted. That is, the P-axis direction corresponds to the rotation direction around the rotation center axis of the probe 10. The angle of the probe 10 with respect to the Z-axis direction can be adjusted by adjusting the rotation of the holding member 5 in the θ-axis direction.

The position of each part of the component 40 in the R-axis direction can be adjusted by adjusting the rotation around the axis A2 of the stage 6 while the component 40 is fixed to the stage 6. That is, the position or posture of the probe 10 or each part of the component 40 can be set to an arbitrary state by the drive mechanism 3. Thus, the eddy current flaw detection test can be performed more accurately in accordance with the shape of the component 40.

The structure of the drive mechanism 3 is not limited to the illustrated example. The structure of the drive mechanism 3 can be appropriately changed according to the shape, dimensions, installation location of the inspection device 1, the type of the component 40, etc. The drive mechanism 3 can be adjusted in the X-axis direction, the Y-axis direction, the Z-axis direction, the P-axis direction, the θ-axis direction, and the R-axis direction, but is not limited thereto. The number of axes that can be adjusted by the drive mechanism 3 can be appropriately changed according to the shape, dimensions, installation location of the inspection device 1, the type of the component 40, etc.

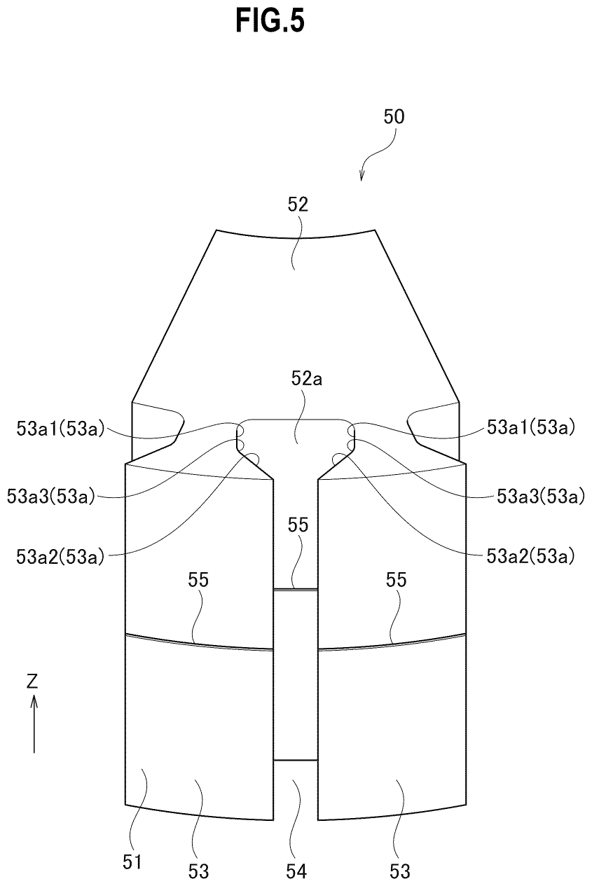

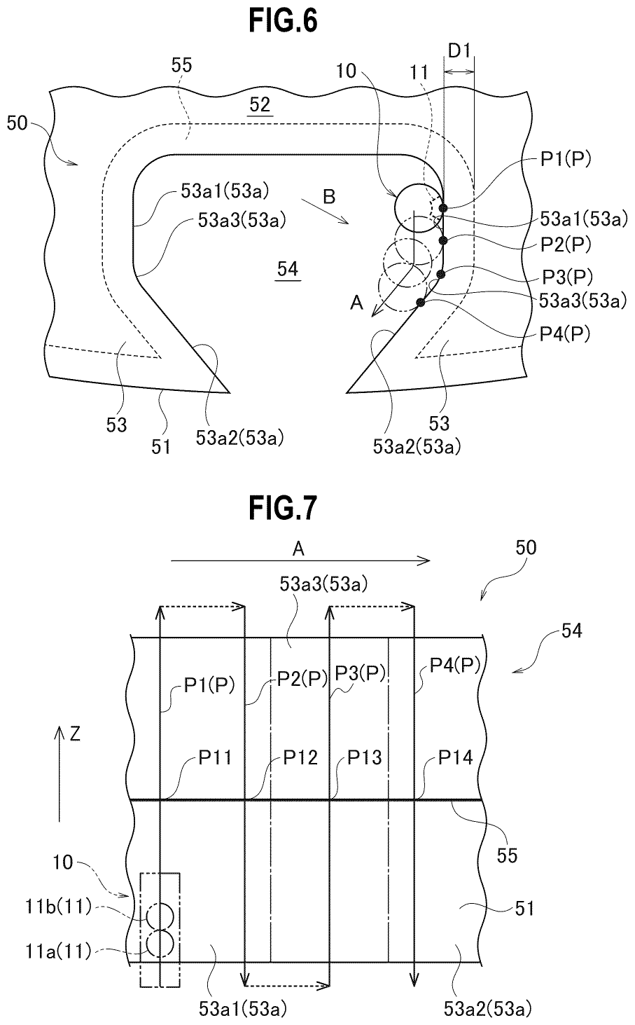

Next, with reference to FIGS. 5 and 6, the standard piece used in the calibration process described later will be described.

The standard piece to be subjected to the eddy current flaw detection test in the calibration process may be disposed in a predetermined region of the upper surface 2a of the inspection device 1. In the inspection device 1 illustrated in FIG. 1, for example, the block 50 (see FIGS. 5 and 6) as the standard piece may be disposed in a region of the upper surface 2a on the negative Y-axis side of the component 40. The block 50 may be fixed to the upper surface 2a using a fixture such as a bracket.

The standard piece is a member having a shape corresponding to the shape of at least a part of the component 40. The standard piece may have a part whose dimensions and shape are substantially identical with at least a part of the component 40. The standard piece has a surface 51. The surface 51 has a shape corresponding to the component surface 41 of the component 40 to be subjected to the eddy current flaw detection test. That is, the surface 51 and at least a part of the component surface 41 have substantially the same radius of curvature in a cross section perpendicular to the scanning direction of the probe 10. Further, the surface 51 may be a surface whose shape and dimensions substantially identical with those of the component surface 41. For example, the standard piece may be formed by cutting a part of a component having substantially the same shape and dimensions as the component 40 to be inspected in the eddy current flaw detection test.

The block 50 illustrated in FIGS. 5 and 6 is a standard piece having substantially the same shape and dimensions as a part of the component 40. The block 50 may be disposed on the upper surface 2a such that, for example, the lower part faces the Z-axis negative direction and the upper part faces the Z-axis positive direction, in FIG. 5. The block 50 may have a body 52, projections 53, and a slot 54. The body 52 has a shape and dimension corresponding to a part of the body 42 of the component 40. The projection 53 corresponds to the projection 43 of the component 40 and has a shape and dimensions that are substantially identical with those of the projection 43. The slot 54 is a groove portion corresponding to the slot 44 of the component 40 and has a shape and dimension dimensions that are substantially identical with those of the slot 44.

The projection 53 is formed to extend from the body 52, and may extend vertically when the block 50 is placed on the upper surface 2a. Two projections 53 are formed in the block 50. The slot 54 is formed between the two projections 53. The slot 54 is a groove portion extending vertically when the block 50 is placed on the upper surface 2a. The slot 54 is defined by an outer peripheral surface 52a of the body 52 and side surfaces 53a of the projections 53. The outer peripheral surface 52a corresponds to the outer peripheral surface 42a of the body 42, and the side surface 53a corresponds to the side surface 43a of the projection 43.

In the example shown in FIG. 5, the side surface 53a includes a first surface 53a1, a second surface 53a2, and a curved surface 53a3. The first surface 53al forms a part of the side surface 53a on the outer peripheral surface 52a side, and has a substantially planar shape. The curved surface 53a3 is a surface directly adjacent to the first surface 53al and is curved with a predetermined curvature when viewed from above. A second surface 53a2 is formed on the side surface 53a opposite to the first surface 53al across the curved surface 53a3. The second surface 53a2 is directly adjacent to the curved surface 53a3 and has a substantially planar shape. The first surface 53a1, the second surface 53a2, and the curved surface 53a3 are continuously connected. That is, when viewed from above, the curved surface 53a3 continuously connects between the first surface 53a1 and the second surface 53a2 with a predetermined radius of curvature. The first surface 53a1 and the second surface 53a2 are smoothly connected by the curved surface 53a3.

A groove portion 55 may be formed on the surface 51 of the block 50. The groove portion 55 is continuously formed at least from the side surface 53a to the outer peripheral surface 52a. The extending direction of the groove portion 55 is not particularly limited, but for example, when the block 50 is disposed on the upper surface 2a, the groove portion 55 may extend on a surface substantially orthogonal to the Z-axis direction. The groove portion 55 may be formed, for example, by electric discharge machining.

The depth of the groove portion 55 may be deeper than the penetration depth of eddy current. That is, the depth D1 of the groove portion 55 illustrated in FIG. 6 is greater than the penetration depth of eddy current generated when an eddy current flaw detection test is performed on the outer peripheral surface 52a or the side surface 53a. The value of the depth D1 of the groove portion 55 is not particularly limited and can be appropriately set according to the material of the block 50, for example. In some embodiments, the depth of the groove portion 55 may be 0.2 mm to 1.6 mm.

The penetration depth of eddy current is the depth where the current density of eddy current is 1/e relative to the current density of eddy current on the surface. “e” is the base of the natural logarithm. The penetration depth δ [m] may be calculated by the following Formula 1. In Formula 1, π is the ratio of a circle's circumference to its diameter (i.e., Pi), f is the frequency [Hz] of the excitation coil, μ is the permeability [H/m] of the object where the eddy current is generated, and σ is the electrical conductivity [×10⁻⁸ S/m] of the object where the eddy current is generated.

$$δ = \sqrt{1 / π f μ σ} \qquad ( Formula 1 )$$

The standard piece is not limited to the block 50 illustrated in FIG. 5. The standard piece may be suitably selected according to the part of the component 40 to be inspected by the eddy current flaw detection test, and kinds of standard pieces may be used. The groove portion 55 is not limited to the example shown in FIG. 5. For example, the shape, size, position, or posture of the groove portion 55 may be suitably set according to the direction of the scanning path P described later.

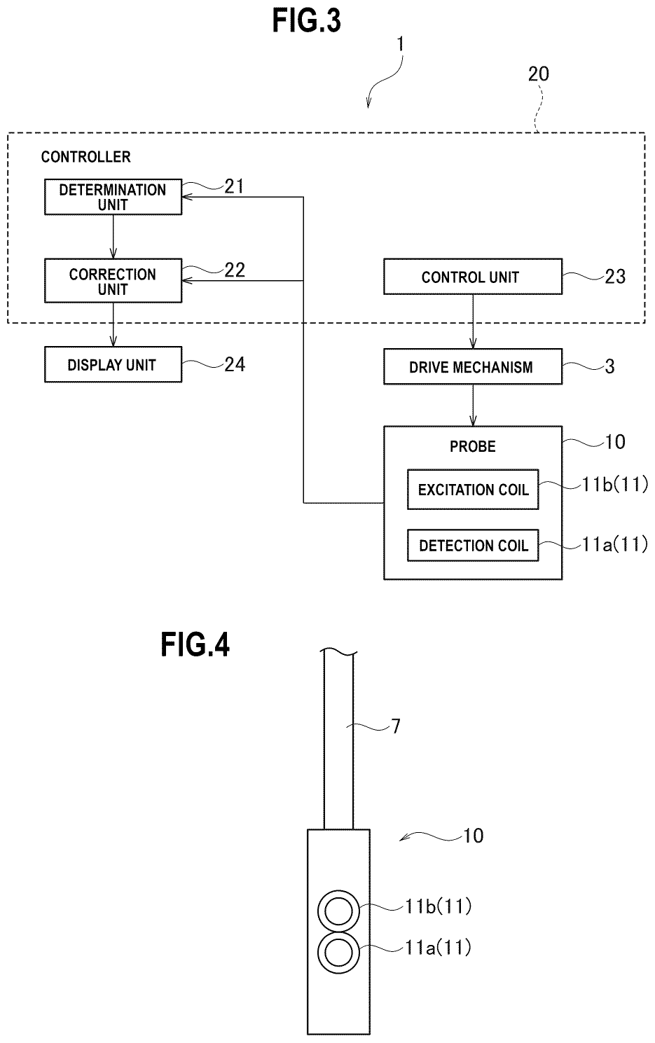

Next, an example of the configuration of the inspection device 1 will be described with reference to FIGS. 3 and 4. As shown in FIG. 3, the inspection device 1 includes a probe 10, a determination unit 21, and a correction unit 22. The determination unit 21 and the correction unit 22 constitute a part of the controller 20 described later.

First, the probe 10 will be described. The probe 10 is a module that scans the surface of the inspection object along a predetermined scanning path and detects a change in eddy current on the surface in the scanning path. The probe 10 is connected to the drive mechanism 3 via the probe shaft 7.

As illustrated in FIG. 4, the probe 10 has a substantially cylindrical shape extending in a direction parallel to the extending direction of the probe shaft 7. A coil 11 is disposed on the side portion of the probe 10. The coil 11 may include an excitation coil 11a and a detection coil 11b. The excitation coil 11a is a coil for generating eddy current on the surface of the inspection object. The detection coil 11b is a coil for detecting the magnetic field induced by the eddy current.

In the eddy current flaw detection test, the probe 10 scans a predetermined scanning path. At this time, eddy current is generated on the surface of the inspection object by the excitation coil 11a through which AC current flows. When a defect such as a crack exists in the inspection object, the eddy current changes due to the effect of the defect. Therefore, the magnetic field induced by the eddy current changes. This change in the magnetic field is detected by the detection coil 11b, and a signal indicating the change in the eddy current can be obtained.

In the example shown in FIG. 4, the excitation coil 11a and the detection coil 11b are directly adjacent to each other in the extending direction of the probe 10, and the detection coil 11b is disposed on the probe shaft 7 side of the excitation coil 11a. However, the position of the excitation coil 11a or the detection coil 11b in the probe 10 is not limited to the position shown in FIG. 4, and may be appropriately changed according to the shape of the inspection object, for example.

Next, the controller 20 will be described. The controller 20 includes the determination unit 21 and the correction unit 22 (see FIG. 3). The controller 20 is a unit that performs processes necessary for the eddy current flaw detection test. For example, the controller 20 may be a general-purpose microcomputer that includes a central processing unit (CPU), a memory, an input/output unit, and the like. In the memory of the microcomputer, a computer program including predetermined rules and instructions for processes of the eddy current flaw detection test is installed. By executing the computer program, the microcomputer can perform the eddy current flaw detection test. The controller 20 may be disposed, for example, in the inspection device 1.

The determination unit 21 determines the sensitivity of the probe 10 based on the intensity of the first signal in a calibration process described later. The first signal is a signal indicating a change in the first eddy current described later. In the calibration process, the probe 10 scans the surface 51 of the block 50 along each of scanning paths P described later. Therefore, the determination unit 21 may associate each of the scanning paths P with the sensitivity of the probe 10. That is, the determination unit 21 may determine the sensitivity of the probe 10 in each of the scanning paths P. The determination unit 21 may also determine the sensitivity of the probe 10 based on the intensity of the first signal detected when the probe 10 scans across the groove portion 55.

In an inspection process described later, the correction unit 22 corrects the intensity of the second signal based on the sensitivity of the probe 10 determined by the determination unit 21. The second signal is a signal indicating a change in the second eddy current described later. That is, the correction unit 22 can correct the intensity of the signal obtained by the eddy current flaw detection test. When correcting the signal, a correction value calculated by a predetermined method may be used. Further, the correction unit 22 may output a corrected signal to the display unit 24 described later. The corrected signal is a signal obtained by correcting the signal obtained by the eddy current flaw detection test in the inspection process. The corrected value may be calculated by the correction unit 22.

The controller 20 may include a control unit 23. A drive mechanism 3 is connected to the control unit 23. The drive mechanism 3 sets the position or posture of each part of the probe 10 or the component 40 based on the command output from the control unit 23. For example, the control unit 23 outputs to the drive mechanism 3 a control value for controlling the position, posture, or rotation of the first slider 4a, the second slider 4b, the third slider 4c, the holding member 5, or the stage 6. That is, the control unit 23 can control the position or posture of each part of the probe 10 or the component 40.

A display unit 24 may be connected to the controller 20. The display unit 24 is connected to the correction unit 22 and can display the corrected signal obtained from the correction unit 22. The display unit 24 may be, for example, a liquid crystal display or a touch panel display. Note that the information displayed on the display unit 24 is not particularly limited, and arbitrary information such as the corrected signal and measurement conditions when performing the eddy current flaw detection test may be displayed.

Next, with reference to FIGS. 6 and 7, an operation example of the inspection device 1 will be described, taking as an example the case where the side surface 43a of the component 40 is inspected by the eddy current flaw detection test. In the eddy current flaw detection test performed by the inspection device 1, a calibration process and an inspection process are performed. The calibration process is performed before the component 40 is inspected by the eddy current flaw detection test. The inspection process is a process where the component 40 is inspected by the eddy current flaw detection test and is performed after the calibration process.

### [Calibration Process]

First, the calibration process will be described. In the calibration process, an eddy current flaw detection test for the block 50 is performed. More specifically, a first scanning process and a first determination process are performed. In the first scanning process, the surface 51 of the block 50 is scanned by the probe 10 along scanning paths P to detect a change in the first eddy current. Here, the scanned surface 51 has a shape corresponding to the component surface 41 inspected by the eddy current flaw detection test in the inspection process described later. The first eddy current is an eddy current generated on the surface 51 of the block 50 in each of the scanning paths P. In the first determination process, the determination unit 21 determines the sensitivity of the probe 10 based on the intensity of the first signal in each of the scanning paths P.

The first scanning process will be described with reference to FIGS. 6 and 7. As an example of this process, the probe 10 scans the side surface 53a that defines a part of the slot 54. In the first scanning process in this example, it is assumed that the side surface 43a of the component 40 is inspected in the inspection process. Therefore, the probe 10 scans the side surface 53a corresponding to the side surface 43a. In the example shown in FIGS. 6 and 7, the paths P1, P2, P3, and P4 are set as the scanning paths P of the probe 10. Each of the paths P1 to P4 is set on the side surface 53a of the projection 53, and may extend in the Z-axis direction. Each of the paths P1 to P4 may extend across the groove portion 55. The paths P1 to P4 correspond to the scanning paths of the probe 10 on the side surface 43a when the eddy current flaw detection test is performed on the side surface 43a of the component 40 in the inspection process.

The extending directions of the paths P1 to P4 are not limited to the Z-axis direction. For example, the paths P1 to P4 may extend in a direction inclined to the Z-axis direction. Further, the paths P1 to P4 are not limited to linear paths. For example, the paths P1 to P4 may be curved paths.

The path P1 is a path that scans a region of the first surface 53al on the outer peripheral surface 52a side in the Z-axis direction. The path P2 is a path that scans a region of the first surface 53a1 adjacent to the curved surface 53a3 in the Z-axis direction. The path P3 is a path that scans the curved surface 53a3 in the Z-axis direction. The path P4 is a path that scans a region of the second surface 53a2 adjacent to the curved surface 53a3 in the Z-axis direction. That is, in the paths P1, P2, and P4, the substantially flat first surface 53al and the second surface 53a2 are the surfaces to be scanned by the probe 10. On the other hand, in the path P3, the curved surface 53a3, which is curved when viewed from above, is the surfaces to be scanned. That is, the shapes of the surfaces to be scanned by the probe 10 are different between the paths P1, P2, and P4 and the path P3 in the calibration process. As described above, the scanning paths P include paths in which the shapes of the surfaces (i.e., the surface scanned by the probe 10) to be scanned by the probe 10 are different. Note that “the shapes of the surfaces are different” means, for example, that the radii of curvature of the surfaces are different in the cross section orthogonal to the scanning direction scanned by the probe 10. For example, the first surface 53al and the second surface 53a2, and the curved surface 53a3 have different radii of curvature in the plane orthogonal to the Z-axis direction. Therefore, the shapes of the surfaces are different between the first surface 53a1 and the second surface 53a2, and the curved surface 53a3.

In the first scanning process, as indicated by the arrow A, scanning is performed continuously from the path P1 to the path P4. For example, as shown in FIG. 7, after scanning is performed along the path P1, the probe is moved in the direction of the arrow A, and scanning is performed along the path P2. After scanning is performed along the path P2, the probe is similarly moved to perform scanning along the path P3, and after scanning is performed along the path P3, the probe is similarly moved to perform scanning along the path P4.

In the example shown in FIG. 7, the probe 10 scans the path P1 in the positive Z-axis direction, the path P2 in the negative Z-axis direction, the path P3 in the positive Z-axis direction, and the path P4 in the negative Z-axis direction. However, the scanning direction of the probe 10 is not limited to this example. For example, the probe 10 may scan the paths P1 to P4 in the direction opposite to the direction shown in the figure.

In the first scanning process, while moving the probe 10 along the paths P1 to P4, a change in the first eddy current occurring on the surface 51 in each of the paths P1 to P4 is detected. The paths P1 to P4 are shown as typical examples of the scanning paths P. However, the scanning paths P is not limited to this example. For example, other scanning paths extending in the Z-axis direction may be further set between the paths P1 to P4.

In the example shown in FIG. 7, the paths P1 to P4 extend across the groove portion 55. Therefore, when the probe 10 crosses the points P11, P12, P13, and P14, relatively large changes in the first eddy current are detected. Each of the points P11 to P14 is an intersection with the groove portion 55 in each of the paths P1 to P4. The change in the eddy current occurs because the flow path of the first eddy current moving in the surface 51 along with the movement of the probe 10 changes due to the influence of the groove portion 55. That is, a change in the first eddy current caused by an edge effect generated when scanning the vicinity of the points P11 to P14 is detected. Therefore, the inspection device 1 detects a first signal indicating a change in the first eddy current at least in the vicinity of each of the points P11 to P14. That is, the first signal may be a signal indicating a change in the first eddy current detected when the probe 10 scans across the groove portion 55.

The inspection device 1 can detect the intensity of the signal indicating a change in the eddy current as, for example, a voltage (V). The paths P1, P2, and P4 are paths for scanning the first surface 53al or the second surface 53a2, which is substantially flat. Therefore, the coil 11 can be made sufficiently close to the side surface 53a. On the other hand, the path P3 is a path for scanning the surface 53a3 which is curved. Therefore, the coil 11 cannot be brought sufficiently close to the side surface 53a, and there is a possibility that a gap may occur between the coil 11 and the side surface 53a. In such a case, the voltage detected at the point P13 may be lower than the voltage detected at the points P11, P12, and P14. In other words, the sensitivity of the probe 10 when scanning the path P3 may be lowered.

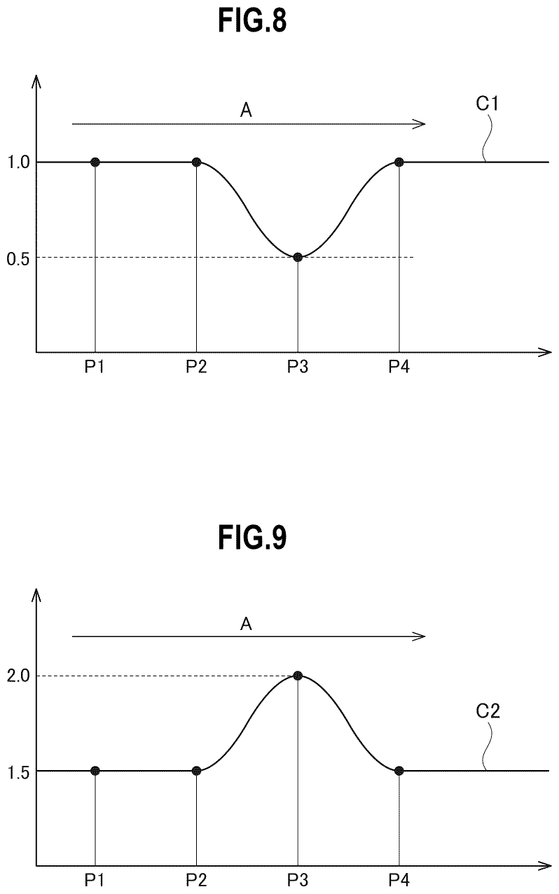

Next, the first determination process will be described with reference to FIG. 8. In the first determination process, the determination unit 21 determines the sensitivity of the probe 10. The first determination process is performed after the first scanning process. The graph in FIG. 8 shows an example of the sensitivity of the probe 10 in each of the paths P1 to P4. The vertical axis of the graph represents the sensitivity of the probe 10, and the horizontal axis represents the scanning path. The sensitivity of the probe 10 may be greater than 0 and expressed as a value of 1 or less. For example, among the first signals in the paths P1 to P4, the sensitivity of the probe 10 in the path where the signal with the maximum intensity is detected may be set to 1.

Moreover, the sensitivity of the probe 10 in the scanning path (second path) other than the scanning path (first path) where the signal with the maximum intensity is detected among the scanning paths may be calculated based on the ratio between the intensity of the signal with the maximum intensity and the intensity of the signal in the path (second path) other than the scanning path (first path) where the signal with the maximum intensity is detected. Briefly, the sensitivity of the probe 10 in the second path may be calculated based on the ratio between the signal intensity obtained by scanning the first path and the signal intensity obtained by scanning the second path. For example, among the first signals detected in the paths P1 to P4, if the first signal detected at points P11, P12, and P14 has the maximum intensity, the sensitivity of the probe 10 in the paths P1, P2, and P4 as the first path may be set to 1. The maximum intensity may be, for example, 2 V. Then, for example, if the first signal detected at point P13 is a signal of 1 V, the sensitivity of the probe 10 in the path P3 may be set to 0.5.

In the graph illustrated in FIG. 8, the sensitivity of the probe 10 in the paths P1, P2, and P4 is 1.0, and the sensitivity of the probe 10 in the path P3 is 0.5. Since the first surface 53a1 and the second surface 53a2 are substantially flat surfaces, the sensitivity of the probe 10 is 1.0 when the region between the paths P1 and P2 of the side surface 53a or the region closer to the arrow A direction than the path P4 is scanned in the Z-axis direction.

In the region between the paths P2 and P4, the curved surface 53a3 is scanned. Therefore, the sensitivity of the probe 10 continuously decreases in the region between the paths P2 and P3 of the side surface 53a. The sensitivity of the probe 10 continuously increases between the paths P3 and P4.

The determination unit 21 associates each of the scanning paths P with the sensitivity of the probe 10 in each of the scanning paths P. Thus, a sensitivity curve C1 representing the relationship between each of the scanning paths P and the sensitivity of the probe 10 in each of the scanning paths P is obtained. The sensitivity curve C1 may be stored in the determination unit 21. The range of values that can be obtained for the sensitivity of the probe 10 is not particularly limited, and the range of values of the sensitivity may be appropriately set according to, for example, the characteristics of the inspection device 1 and the probe 10.

In the calibration process described above, the probe 10 scans the side surface 53a among the surface 51 of the block 50, which corresponds to the side surface 43a of the component 40. Based on the intensity of the first signal obtained as a result, the sensitivity of the probe 10 in each of the paths P1 to P4 is determined. Therefore, the sensitivity corresponds to the sensitivity of the probe 10 when the side surface 43a of the component 40 is scanned along the path corresponding to each of the paths P1 to P4 in the inspection process.

In the calibration process, a second determination process may be performed. In the second determination process, a correction value is determined based on the sensitivity of the probe 10 determined by the determination unit 21. The second determination process may be performed by the correction unit 22.

The second determination process will be described with reference to FIG. 9. The second determination process is a process which determines a correction value corresponding to each of the scanning paths P based on the sensitivity of the probe 10. The second determination process may be performed after the first determination process. FIG. 9 shows an example of a correction value corresponding to each of the paths P1 to P4. The vertical axis of the graph represents the correction value, and the horizontal axis represents the scanning path. The correction value may be 1 or more.

The correction value may be the inverse of the sensitivity of the probe 10. For example, the sensitivity of the probe 10 in paths P1, P2, and P4 is 1.0 (see FIG. 8). Therefore, the correction value in paths P1, P2, and P4 is 1.0. The sensitivity of the probe 10 in path P3 is 0.5 (see FIG. 8). Therefore, the correction value in the path P3 is 2.0.

When the region between the paths P1 and P2 or the region on the side of the arrow A direction from the path P4 in the side surface 53a is scanned in the Z-axis direction, the sensitivity of the probe 10 is 1.0. Therefore, the correction value corresponding to these regions is 1.0. In the region between the paths P2 and P3 in the side surface 53a, the sensitivity of the probe 10 continuously decreases. Therefore, the correction value continuously increases between the paths P2 and P3. In the region between the paths P3 and P4 in the side surface 53a, the sensitivity of the probe 10 continuously increases. Therefore, the correction value continuously decreases between the paths P3 and P4.

The correction unit 22 associates each of the scanning paths P with the correction value corresponding to each of the scanning paths P. Thus, a correction curve C2, which represents the relationship between each of the scanning paths P and the correction value corresponding to each of the scanning paths P, is obtained. The correction curve C2 may be stored in the correction unit 22. The calculation method of the correction value is not limited thereto, and the calculation method may be appropriately changed according to, for example, the amount of change in the sensitivity of each scanning path.

### [Inspection Process]

The inspection process is a process of inspecting the component 40 by an eddy current flaw detection test. The inspection process is performed after the calibration process. In the inspection process, a second scanning process is performed. In the second scanning process, the component surface 41 of the component 40 is scanned by the probe 10, and a second signal indicating a change in the second eddy current is detected. The second eddy current is an eddy current generated on the component surface 41 when the component surface 41 is scanned by the probe 10. For example, the component surface 41 may be the side surface 43a. When a part of the same type as the component 40 is continuously inspected after the inspection process of the component 40 is completed, the inspection process of the component may be performed after the inspection process of the component 40 without performing the calibration process again.

In the first determination process of the calibration process, the sensitivity of the probe 10 in each of the paths P1 to P4 of the block 50 is determined by the determination unit 21. Here, the paths P1 to P4 correspond to the scanning paths of the probe 10 when the side surface 43a is scanned in the inspection process. Therefore, the sensitivity of the probe 10 in each of the paths P1 to P2 corresponds to the sensitivity of the probe 10 in each of the scanning paths when the side surface 43a is scanned. That is, similarly to the case illustrated in FIG. 8, in the second scanning process, the sensitivity of the probe 10 when scanning along the path corresponding to the path P3 is lower than the sensitivity of the probe 10 when scanning along the path corresponding to the paths P1, P2, or P4.

The second signal detected in the second scanning process is corrected by a correction process. In the correction process, the correction unit 22 corrects the intensity of the second signal based on the sensitivity of the probe 10 determined in the first determination process. Thus, even in the scanning path where the sensitivity of the probe 10 decreases, a signal indicating the presence of a defect can be detected more accurately. That is, the eddy current flaw detection test of the component surface 41 can be performed more accurately. Therefore, the eddy current flaw detection test can be performed without changing the probe 10 according to the shape of the side surface 43a, for example. Consequently, the inspection device 1 can perform the eddy current flaw detection test more easily.

The correction of the intensity of the second signal by the correction unit 22 may be performed by using a correction curve C2 (see FIG. 9). For example, the intensity of the second signal may be corrected by multiplying the voltage value obtained by scanning the side surface 43a along the paths corresponding to the paths P1 to P4 by the correction value associated with the paths P1 to P4. In the correction curve C2 illustrated in FIG. 9, the correction value corresponding to the paths P1, P2, and P4 is 1.0. The correction value corresponding to the path P3 is 2.0. Therefore, the voltage of the second signal obtained by scanning the side surface 43a along the paths corresponding to the paths P1, P2, and P4 may be multiplied by the correction value 1.0. Further, the voltage of the second signal obtained by scanning the side surface 43a along the path corresponding to the path P3 may be multiplied by the correction value 2.0. Note that the method of correcting the second signal is not limited to this method, and the method may be appropriately changed according to, for example, the shape of the correction curve C2 and the range within which the correction value can be obtained.

The preparation process may be performed before the calibration process and the inspection process described above. The preparation process is a process of setting the sensitivity of the probe 10 to a predetermined sensitivity in advance. In the preparation process, the sensitivity of the probe 10 may be calibrated using a calibration block (not shown) in which a standard defect is formed. The standard defect may be, for example, a crack whose longitudinal dimension and depth are set to predetermined values. In the preparation process, such a calibration block may be scanned by the probe 10, and the sensitivity of the probe 10 may be set so that a signal with a predetermined intensity is detected near the standard defect. Thus, the sensitivity of the probe 10 can be set more accurately.

Next, the eddy current flaw detecting device according to the embodiment and the effects of the eddy current flaw detecting method will be described.

(1) The eddy current flaw detecting device according to the embodiment is an eddy current flaw detecting device 1 for inspecting a component surface 41. The device 1 includes a probe 10 that scans a surface 51 of a standard piece 50, the surface having a shape corresponding to a component surface 41, along scanning paths P on the surface to be scanned having different shapes, and detecting a change in a first eddy current on the surface 51 of the standard piece 50 in each of the scanning paths P. The device 1 includes a determination unit 21 that determines a sensitivity of the probe 10 in each of the scanning paths P based on an intensity of a first signal indicating a change in the first eddy current in each of the scanning paths P. The device 1 includes a correction unit 22 that corrects an intensity of a second signal indicating a change in a second eddy current on the component surface 41 detected by the probe 10 based on the sensitivity of the probe 10.

According to the eddy current flaw detecting device according to the embodiment, for example, even if the scanning paths for scanning the side surface 43a of the component 40 includes a path where the sensitivity of the probe 10 decreases, the correction can be performed so that the intensity of the second signal obtained by scanning the path increases. Therefore, a signal indicating the existence of a defect can be more reliably detected. Thus, the eddy current flaw detection test can be performed without changing the probe 10 according to the shape of the side surface 43a, for example. Consequently, the eddy current flaw detection test can be performed more easily.

(2) Each of the scanning paths P extends across the groove portion 55 may be formed on the surface of the standard piece 50 and deeper than the penetration depth of the first eddy current, and the first signal may be a signal indicating the change in the first eddy current detected when the probe 10 crosses the groove portion 55.

Thus, the probe 10 can detect a relatively large change in the first eddy current when scanning across the groove portion 55. Accordingly, the inspection device 1 can more reliably determine the sensitivity of the probe 10.

(3) The determination unit 21 may determine the sensitivity based on the ratio of the intensity of the first signal in the first path in which the first signal having the largest intensity among the scanning paths P is detected and the intensity of the first signal in the path other than the first path among the scanning paths P.

Thus, the sensitivity of the probe 10 in each of the scanning paths P can be more reliably determined based on, for example, the intensity of the first signal in the first paths P1, P2, and P4 and the intensity of the first signal in the path P3.

(4) The correction unit 22 may calculate a correction value in each of the scanning paths P based on the sensitivity, and may correct the intensity of the second signal based on the correction value.

Thus, the inspection device 1 can more easily correct the intensity of the second signal detected by scanning the component surface 41 based on the correction curve C2, for example.

(5) The eddy current flaw detecting method according to the embodiment is an eddy current flaw detecting method for inspecting the component surface 41.

In this method, the surface 51 of a standard piece 50 having a shape corresponding to the component surface 41 is scanned by a probe 10 along a scanning paths P on the surface to be scanned having different shapes, and a change in the first eddy current of the surface 51 of the standard piece 50 in each of the scanning paths P is detected. In this method, the sensitivity of the probe 10 in each of the scanning paths P is determined based on the intensity of the first signal indicating the change in the first eddy current in each of the scanning paths P. In this method, the intensity of the second signal indicating a change in the second eddy current of the component surface 41 detected by the probe 10 is corrected based on the sensitivity of the probe 10.

According to the eddy current flaw detecting method according to the embodiment, for example, even if a scanning paths for scanning the side surface 43a of the component 40 include a path where the sensitivity of the probe 10 decreases, correction can be made so that the intensity of the second signal obtained by scanning the path increases. Therefore, a signal indicating the existence of a defect can be more reliably detected. Thus, the eddy current flaw detection test can be performed without changing the probe 10 according to the shape of the side surface 43a, for example. Therefore, the eddy current flaw detection test can be performed more easily.

The present disclosure can contribute to, for example, Goal 9 “Building resilient infrastructure, promoting inclusive and sustainable industrialization, and promoting innovation” of the Sustainable Development Goals (SDGs).

Although some embodiments have been described above, the embodiments can be modified or modified based on the above disclosure. All components of the above embodiments and all features described in the claims may be individually extracted and combined as long as they are consistent with each other.

What is claimed is:

1. An eddy current flaw detecting device for inspecting a component surface, comprising:
a probe configured to scan a surface of a standard piece, the surface having a shape corresponding to the component surface, along scanning paths on the surface to be scanned having different shapes, and detecting a change in a first eddy current on the surface of the standard piece in each of the scanning paths;
a determination unit configured to determine a sensitivity of the probe in each of the scanning paths based on an intensity of a first signal indicating a change in the first eddy current in each of the scanning paths; and
a correction unit configured to correct an intensity of a second signal indicating a change in a second eddy current on the component surface detected by the probe based on the sensitivity.

2. The eddy current flaw detecting device according to claim 1, herein
each of the scanning paths extends across a groove portion formed on the surface of the standard piece and deeper than a penetration depth of the first eddy current; and
the first signal is a signal indicating the change in the first eddy current detected when the probe crosses the groove portion.

3. The eddy current flaw detecting device according to claim 1, wherein
the determination unit determines the sensitivity based on the ratio of the intensity of the first signal in a first path in which the first signal having the largest intensity among the scanning paths is detected and the intensity of the first signal in the path other than the first path among the scanning paths.

4. The eddy current flaw detecting device according to claim 1, wherein
the correction unit calculates a correction value in each of the scanning paths based on the sensitivity, and corrects the intensity of the second signal based on the correction value.

5. The eddy current flaw detecting device according to claim 2, wherein
the correction unit calculates a correction value in each of the scanning paths based on the sensitivity, and corrects the intensity of the second signal based on the correction value.

6. The eddy current flaw detecting device according to claim 3, wherein
the correction unit calculates a correction value in each of the scanning paths based on the sensitivity, and corrects the intensity of the second signal based on the correction value.

7. An eddy current flaw detecting method for inspecting a component surface, comprising:
scanning a surface of a standard piece by a probe, the surface having a shape corresponding to the component surface, along scanning paths on the surface to be scanned having different shapes, and detecting a change in a first eddy current on the surface of the standard piece in each of the scanning paths;
determining a sensitivity of the probe in each of the scanning paths based on an intensity of a first signal indicating a change in the first eddy current in each of the scanning paths; and
correcting an intensity of a second signal indicating a change in a second eddy current on the component surface detected by the probe based on the sensitivity.
